(19) United States
(12) Patent Application Publication
(10) Pub. No.: US 2016/0113405 A1
(43) Pub. Date: Apr. 28, 2016

(54) POLYURETHANE FOAM FOR SEAT PAD

(71) Applicant: BRIDGESTONE CORPORATION, Tokyo (JP)

(72) Inventor: Kosuke YOSHITOMI, Yokohama-shi (JP)

(73) Assignee: BRIDGESTONE CORPORATION, Tokyo (JP)

(21) Appl. No.: 14/892,450

(22) PCT Filed: May 8, 2014
(86) PCT No.: PCT/JP2014/062393

§ 371 Date: Nov. 19, 2015

(30) Foreign Application Priority Data
May 24, 2013 (JP) 2013-109850

(51) Int. Cl. A47C 7/18; B29C 44/02; B60N 2/70

(52) U.S. Cl. CPC A47C 7/18; B60N 2/70; B29C 44/02; B29K 2075/00

(57) ABSTRACT

A polyurethane foam for a seat pad that simultaneously achieves higher levels of shakiness-reducing properties and stress relaxation-reducing properties, thus providing good ride comfort, and is excellent in durability, and a seat pad using the polyurethane foam are provided. Specifically, the polyurethane foam for a seat pad is formed by foam-molding a foaming liquid containing (A) a polyol component, (B) a polyisocyanate component, and (C) a crosslinking agent.

### TECHNICAL FIELD

The present invention relates to a polyurethane foam for a seat pad, and particularly relates to a polyurethane foam for a seat pad that is optimum for a vehicle seat pad.

### BACKGROUND ART

Polyurethane foams have been demanded to have various properties, including mechanical properties, heat insulating properties, and vibration absorbing properties, depending on purposes, and particularly in vehicle seat pads and the like, high repulsive elasticity and comfort, such as comfort to sit, have been demanded.

A vehicle seat pad often suffers a problem that a seat fails to support the human body due to the centrifugal force applied to the body when the vehicle changes the lanes or goes round a curve, thus shaking the body. For reducing such shakiness, such measures have been made that (1) the molecular weight of a polyether polyol used as a raw material for the polyurethane foam is changed from a high molecular weight to a low molecular weight, (2) in the repeating units derived from ethylene oxide and repeating units derived from propylene oxide in the polyether polyol, the proportion of the ethylene oxide units is increased, (3) the water content in the foaming liquid for forming a polyurethane foam is increased, and (4) the amount of the crosslinking agent is increased.

On taking the measures, however, there may be a possibility that the repulsive elasticity and the air permeability of the resulting polyurethane foam are lowered, and the “stress relaxation”, which is important for the ride comfort, is deteriorated (increased). That is, there is a trade-off relationship between the shakiness-reducing properties and the stress relaxation-reducing properties, i.e. when the shakiness is improved (lowered), the stress relaxation is deteriorated (increased), and when the stress relaxation is improved, the shakiness is deteriorated. Therefore, it has been difficult to retain both the shakiness-reducing properties and the stress relaxation-reducing properties at higher levels.

In order to solve the problem, with regard to a polyurethane foam produced by foam-molding a polyurethane foaming liquid containing a polyol component and an isocyanate component as main components, the present inventors have developed a lightweight polyurethane foam having excellent vibration absorbing properties, in which a polyether polyol having a molecular weight of from 3,000 to 12,000, an unsaturation degree of 0.03 mEq/g or less and a ratio of “molecular weight/number of functional group” of from 1,000 to 3,000 is used as the polyol, and an organically-modified inorganic filler is mixed therein (see PTL 1), and further have developed a polyurethane foam, in which the polyol component contains, based on the polyol component, from 40% to 55% by mass of (a-1) a polyether polyol that is obtained through ring opening polymerization of ethylene oxide and propylene oxide, has a molar ratio of the repeating unit derived from ethylene oxide to the repeating unit derived from propylene oxide of from 5/95 to 25/75, and has a number average molecular weight of from 6,000 to 8,000, the polyol component further contains, based on the polyol component, from 5 to 15% by mass of (a-2) a polyether polyol that is obtained through ring opening homopolymerization of propylene oxide or through ring opening polymerization of ethylene oxide and propylene oxide, has a molar ratio of repeating units derived from ethylene oxide to repeating units derived from propylene oxide of from 0/100 to 20/80, and has a number average molecular weight of from 600 to 2,000, and the amount of water contained therein is 2.0 parts by mass or more per 100 parts by mass of the total polyol components (see PTL 2).

### CITATION LIST

### Patent Literatures

PTL 1: JP-A-2008-127514

PTL 2: WO 2011/132645

### SUMMARY OF INVENTION

### Technical Problem

However, when the polyurethane foam disclosed in PTL 1 is used as a vehicle seat pad, the seat pad sometimes shakes during turning a corner. If the degree of shakiness is larger, it is expected that the inclination of the human body becomes larger when a centrifugal acceleration was applied thereto during turning a corner. Therefore, there has still been a room for improvement in the ride comfort.

The degree of the shakiness is improved (lowered) in the polyurethane foam disclosed in PTL 2. However, the stress relaxation is not necessarily reduced, and there has been a room for improvement in the ride comfort. Furthermore, the hygrothermal compressive residual strain is increased in some cases, and there has still been a room for improvement in the durability.

Thus, a problem to be solved by the present invention is to provide a polyurethane foam for a seat pad that simultaneously achieves higher levels of shakiness-reducing properties and stress relaxation-reducing properties, thus providing good ride comfort, and is excellent in durability.

### Solution to Problem

As a result of earnest investigations made by the present inventors, it has been found that the problem can be solved by a polyurethane foam produced by foam-molding a foaming liquid containing (A) a polyol component, (B) a polyisocyanate component, and (C) a crosslinking agent, in which the polyol component contains particular two kinds of polyether polyols, and a particular crosslinking agent is used. The present invention has been completed based on the knowledge.

The present invention relates to the following items [1] to [4].

[1] A polyurethane foam for a seat pad formed by foam-molding a foaming liquid containing (A) a polyol component, (B) a polyisocyanate component, and (C) a crosslinking agent, wherein:

the polyol component (A) includes (a-1) a polyether polyol that is a block copolymer that is obtained through ring opening polymerization of ethylene oxide and propylene oxide, has a molar ratio of a repeating unit derived from ethylene oxide to a repeating unit derived from propylene oxide of from 5/95 to 25/75 and has a number average molecular weight of from 6,000 to 8,000, in a ratio of from 30 to 55% by mass in the polyol component (A) and (a-2) a polyether polyol that is obtained through ring opening polymerization of propylene oxide only, or ethylene oxide and propylene oxide, has a molar ratio of a repeating unit derived from ethylene oxide to a repeating unit derived from propylene oxide of from 0/100 to 20/80 and has a number average molecular weight of from 600 to 2,000, in a ratio of from 2 to 20% by mass in the polyol component (A); and

the crosslinking agent (C) includes a polyether polyol that is obtained through ring opening polymerization of ethylene oxide only, and has a number average molecular weight of from 500 to 1,500.

[2] The polyurethane foam for a seat pad according to the item [1], wherein an amount of the crosslinking agent (C) contained is from 0.5 to 10% by mass based on the total amount of the polyol component (A) and the crosslinking agent (C).

[3] The polyurethane foam for a seat pad according to the item [1] or [2], wherein the polyol component (A) further includes (a-3) a polymer polyol that is obtained through graft copolymerization of an acrylonitrile-styrene copolymer to a polyether polyol which is obtained through ring opening polymerization of ethylene oxide and propylene oxide, has a molar ratio of a repeating unit derived from ethylene oxide to a repeating unit derived from propylene oxide of from 5/95 to 25/75 and has a number average molecular weight of from 3,000 to 7,000, in a ratio of from 40 to 60% by mass in the polyol component (A).

[4] A seat bad including the polyurethane foam according to any one of the items [1] to [3].

### Advantageous Effects of Invention

According to the present invention, a polyurethane foam for a seat pad which simultaneously achieves higher levels of shakiness-reducing properties and stress relaxation-reducing properties, thus providing good ride comfort, and which is excellent in durability, can be provided.

### BRIEF DESCRIPTION OF THE DRAWING

FIG. 1 is a graph showing the relationship between the stress relaxation and the viscoelasticity evaluated in Examples and Comparative Examples.

### DESCRIPTION OF EMBODIMENTS

The polyurethane foam for a seat pad of the present invention (which may be hereinafter referred simply to as a urethane foam) is formed by foam-molding a foaming liquid containing (A) a polyol component, (B) a polyisocyanate component, and (C) a crosslinking agent.

The components will be described in detail respectively below. In the description, the preferred items and the preferred numerals may be used arbitrarily, and combinations selected from the preferred items and the preferred numerals are more preferred.

### (A) Polyol Component

In the foaming liquid, the polyol component used as the component (A) contains the component (a-1) and the component (a-2) described below as essential components, provided that the component (A) does not contain the component (C) described later.

(a-1) Polyether Polyol

The polyether polyol as the component (a-1), which is a polyether polyol having a relatively large molecular weight, is a block copolymer that is obtained through ring opening polymerization of ethylene oxide (which may be hereinafter referred to as EO) and propylene oxide (which may be hereinafter referred to as PO), has a molar ratio of the repeating unit derived from EO to the repeating unit derived from PO (EO/PO) of from 5/95 to 25/75, and has a number average molecular weight of from 6,000 to 8,000. In particular, from the standpoint of the moldability and the reactivity, it is preferred that a block formed of EO units is present at the molecular end, and it is more preferred that the interior of the molecule is a block formed of PO units and the molecular end is a block formed of EO units. The amount of EO units present in the interior of the molecule is preferably 5% by mol or less, more preferably 3% by mol or less, and further preferably substantially 0% by mol.

The component (a-1) may particularly improve the stress relaxation-reducing properties. The component (a-1) may be used as a single kind or as a combination of two or more kinds thereof.

The molar ratio of the repeating unit derived from EO to the repeating unit derived from PO (EO/PO) is necessarily from 5/95 to 25/75 as described above, preferably from 8/92 to 25/75, and more preferably from 10/90 to 20/80.

The number average molecular weight thereof is necessarily in a range of from 6,000 to 8,000. When the number average molecular weight of the component (a-1) is less than 6,000, the repulsive elasticity is lowered, and when number average molecular weight thereof exceeds 8,000, the shakiness cannot be reduced. In this point of view, the number average molecular weight is preferably in a range of from 7,000 to 8,000.

Additionally, in the present invention, the number average molecular weight refers to a value which is calculated in terms of polystyrene by gel permeation chromatography (GPC method).

The number of hydroxyl groups contained in one molecule of the component (a-1) is generally preferably from 2 to 4, and more preferably 3. When the number of hydroxyl groups is 4 or less, the viscosity of the raw material may not be increased.

(a-2) Polyether Polyol

The polyether polyol as the component (a-2), which is a polyether polyol having a relatively small molecular weight as compared to the component (a-1), is obtained through ring opening polymerization of PO only, or EO and PO, has a molar ratio of the repeating unit derived from EO to the repeating unit derived from PO (EO/PO) of from 0/100 to 20/80, and has a number average molecular weight of from 600 to 2,000. The component (a-2) may particularly improve the shakiness-reducing properties effectively. The component (a-2) may be used as a single kind or as a combination of two or more kinds thereof.

When the molar ratio is outside the range, i.e., exceeds 20/80, the air permeability becomes too large, and the shakiness is increased, thereby failing to achieve the object of the present invention. From the standpoint of the shakiness-reducing properties, the molar ratio is preferably from 0/100 to 10/90, and more preferably from 0/100 to 5/95. Furthermore, from the standpoint of the shakiness-reducing properties, the component (a-2) is preferably obtained through ring opening polymerization of PO only, i.e., preferably has a molar ratio EO/PO of 0/100.

When the number average molecular weight of the component (a-2) is less than 600, the stress relaxation is increased, and when the average molecular weight thereof exceeds 2,000, the shakiness is increased. In view of these points of view, the number average molecular weight of the component (a-2) is preferably from 650 to 1,500, and more preferably from 700 to 1,200.

The number of hydroxyl groups contained in one molecule of the component (a-2) is generally from 2 to 4, and preferably 3. When the number of hydroxyl groups is 4 or less, the viscosity of the raw material may not be increased.

In the present invention, the amounts of the polyether polyol (a-1) and the polyether polyol (a-2) contained in the polyol component (A) are from 30 to 55% by mass (and preferably from 30 to 50% by mass) for the component (a-1) and from 2 to 20% by mass (preferably from 2 to 15% by mass, and more preferably from 2 to 10% by mass) for the component (a-2), from the standpoint of the achievement of both the shakiness-reducing properties and the stress relaxation-reducing properties. The balance is an additional polyol component, including a component (a-3) described later.

### Additional Component (A)

The component (A) may often contain an additional polyol component other than the component (a-1) and the component (a-2), and examples thereof include a component (a-3) shown below.

(a-3) Polyether Polyol

A polymer polyol as the component (a-3) is a polymer polyol obtained through graft copolymerization of an acrylonitrile-styrene copolymer to a polyether polyol which is obtained through ring opening polymerization of EO and PO, has a molar ratio of the repeating unit derived from EO to the repeating unit derived from PO of from 5/95 to 25/75, and has a number average molecular weight of from 3,000 to 7,000. The polyether polyol is preferably a block copolymer that is obtained through ring opening polymerization of EO and PO. It is preferred that a block formed of EO units is present at the molecular end, and it is more preferred that the interior of the molecule is a block formed of PO units, and the molecular end is a block formed of EO units. The amount of EO units present in the interior of the molecule is preferably 5% by mol or less, more preferably 3% by mol or less, and further preferably substantially 0% by mol.

The polymer polyol may impart hardness to the urethane foam, and in the evaluation of the stress relaxation-reducing properties and the shakiness-reducing properties, the component (a-3) may be effectively used for standardizing specimens in hardness.

When the molar ratio of the repeating unit derived from EO to the repeating unit derived from PO in the component (a-3) is within the aforementioned range, favorable moldability may be retained. From the same point of view, the molar ratio of the repeating unit derived from EO to the repeating unit derived from PO (EO/PO) in the component (a-3) is preferably from 10/90 to 20/80.

Furthermore, when the number average molecular weight of component (a-3) is within the aforementioned range, the viscosity may not become large, and mass productivity may also be retained. Form the same point of view, the number average molecular weight is preferably from 4,000 to 6,000.

The number of hydroxyl groups contained in one molecule of the component (a-3) is generally preferably from 2 to 4, and particularly 3. When the number of hydroxyl groups is 4 or less, the viscosity of the raw material may not be increased.

In cases where component (A) contains the component (a-3), the amount of the component (a-3) contained in the polyol component (A) is generally preferably from 40 to 60% by mass, and more preferably from 45 to 55% by mass.

In the present invention, the viscosity of polyol component (A) (in the case where plural kinds of polyols are mixed and used as the component (A), the viscosity of the mixture of the polyols) is preferably 3,000 mPa·s or less, and more preferably 1,800 mPa·s or less, at a liquid temperature of 25° C. The use of the polymer polyol having a viscosity within the range may suppress the viscosity increasing rate of the polyurethane foaming liquid, thereby enhancing the agitation efficiency of the foaming liquid, and thus the isocyanate groups and the hydroxyl groups can be reacted more uniformly. Consequently, not only the generation efficiency of the generated gas may be increased as compared to the ordinary technique, but also, with regard to gas generation sites, the gas generates uniformly in the polyurethane foaming liquid, thereby providing a lightweight and uniform polyurethane foam-molded article. The “viscosity” in the present invention refers to a viscosity that is measured with a capillary viscometer at a liquid temperature of 25° C. according to JIS Z8803-1991.

### (B) Polyisocyanate Component

The polyisocyanate component used as the component (B) in the foaming liquid may be various types of publicly known polyfunctional aliphatic, alicyclic or aromatic isocyanates. Examples thereof include tolylene diisocyanate (TDI), diphenylmethane diisocyanate (MDI), dicyclohexylmethane diisocyanate, triphenyl diisocyanate, xylene diisocyanate, polymethylene polyphenylene polyisocyanate, hexamethylene diisocyanate, isophorone diisocyanate, o-toluidine diisocyanate, naphthylene diisocyanate, xylylene diisocyanate and lysine diisocyanate, which may be used as a single kind or as a combination of two or more kinds thereof.

In the present invention, tolylene diisocyanate (TDI) and/or diphenylmethane diisocyanate (MDI) are preferably contained from the standpoint of the molding density range.

The amount of the polyisocyanate as the component (B) contained in the foaming liquid is not particularly limited, and for providing a favorable foamed state without agitation failure, the molar ratio of the isocyanate group in the polyisocyanate component to the active hydrogen group in the foaming liquid is preferably from 80/100 to 120/100, and more preferably from 90/100 to 115/100.

### (C) Crosslinking Agent

The polyurethane foaming liquid contains, as the component (C), a polyether polyol that is obtained through ring opening polymerization of ethylene oxide only, and has a number average molecular weight of from 500 to 1,500. The content of the polyether polyol in the component (C) is preferably 70% by mass or more, more preferably 80% by mass or more, further preferably 90% by mass or more, still further preferably 95% by mass or more, and particularly preferably substantially 100% by mass, from the standpoint of the achievement of both the shakiness-reducing properties and the stress relaxation-reducing properties at higher levels, and the durability.

The polyether polyol that is obtained through ring opening polymerization of ethylene oxide only, and has a number average molecular weight of from 500 to 1,500 may be used as a single kind or as a combination of two or more kinds thereof.

In the polyether polyol that is obtained through ring opening polymerization of ethylene oxide only, and has a number average molecular weight of from 500 to 1,500 contained in the component (C), the number of hydroxyl groups contained in one molecule is generally preferably from 2 to 4, and particularly 3. When the number of hydroxyl groups is 4 or less, the viscosity of the raw material may not be increased. The number average molecular weight of the polyether polyol is preferably from 500 to 1,000, and more preferably from 500 to 800.

The component (C) as a crosslinking agent preferably has a molecular weight per one functional group of from 150 to 250, and more preferably from 180 to 230, from the standpoint of the achievement of both the shakiness-reducing properties and the stress relaxation-reducing properties at higher levels, and the durability.

The amount of the crosslinking agent (C) contained in the polyurethane foaming liquid is preferably from 0.5 to 10% by mass, and more preferably from 1 to 6% by mass, based on the total amount of the component (A) and the component (C), from the standpoint of the achievement of both the shakiness-reducing properties and the stress relaxation-reducing properties at higher levels, and the durability. When the content is 10% by mass or less, the moldability may be retained, and disappearance of foam may not be occurred.

### (D) Foaming Agent

The foaming liquid generally contains a foaming agent as a component (D). Water is generally preferably used as the foaming agent. Water forms carbon dioxide gas through reaction with a polyisocyanate, and thus functions as a foaming agent. In addition to water, a foaming agent that is generally used for the production of a urethane foam, such as a hydrogen atom-containing halogenated hydrocarbon, liquefied carbon dioxide, and a hydrocarbon having a low boiling point, may also be used.

The amount of the component (D) contained is not particularly limited, and is preferably from 0.1 to 10 parts by mass, more preferably from 0.3 to 5 parts by mass, and further preferably from 0.3 to 3 parts by mass, per 100 parts by mass of the polyol component (A). When the amount is 0.1 part by mass or more per 100 parts by mass of the polyol component (A), a sufficient effect of suppressing the shakiness may be obtained.

### (E) Catalyst

The foaming liquid may contain a catalyst as a component (E) from the standpoint of the reactivity in foam-molding. The catalyst used may be those having been generally used in the production of a polyurethane foam, and may be used as a single kind or as a combination of two or more kinds thereof depending on purposes and necessity. Specific examples thereof include an amine catalyst, such as tetramethylhexamethylenediamine, pentamethyldiethylenetriamine, dimethylcyclohexylamine, bis(dimethylaminoethyl)ether, tetramethylpropylenediamine, trimethylaminoethylpiperazine, tetramethylethylenediamine, dimethylbenzylamine, methylmorpholine, ethylmorpholine, triethylenediamine and diethanolamine and a tin catalyst, such as stannous octate and dibutyltin laurate. Commercially available products may be used as the catalyst, and examples thereof that may be favorably used include triethylenediamine (“TEDA-L33” produced by Tosoh Corporation) and bis(dimethylaminoethyl)ether (“TOYOCAT-ET” produced by Tosoh Corporation).

The amount of component (E) contained in the foaming liquid is not particularly limited, and in general, the amount thereof is preferably from 0.05 to 0.5 part by mass, more preferably from 0.1 to 5 parts by mass, further preferably from 0.1 to 3 parts by mass, and particularly preferably from 0.1 to 1 part by mass, per 100 parts by mass of the polyol as the component (A).

### Optional Components

The foaming liquid may contain (F) a foam stabilizer and other additives as optional components.

### (F) Foam Stabilizer

The foam stabilizer as a component (F) may be those that have widely been used for polyurethane foam-molded articles, and examples thereof used include various types of silicone foam stabilizers, such as a siloxane-polyether block copolymer.

The amount of the foam stabilizer (F) contained in the polyurethane foaming liquid is generally preferably from 0.3 to 5 parts by mass, more preferably from 0.3 to 3 parts by mass, and further preferably from 0.3 to 2 parts by mass, per 100 parts by mass of the polyols as the component (A). When the amount is 0.3 part by mass or more, good agitation properties of the polyol component and the isocyanate component may be obtained, thereby facilitating the production of the intended urethane foam.

### Additives

Examples of the additives include a colorant, such as a pigment, a chain extender, a filler, such as calcium carbonate, a flame retardant, an antioxidant, an ultraviolet ray absorbent, a light stabilizer, an electroconductive substance, such as carbon black, and an antimicrobial agent. The amounts of the additives contained may be in the ordinary ranges.

### Preparation of Foaming Liquid

The method for preparing the foaming liquid in the present invention is not particularly limited, and preferred examples of the method include a method of preparing a mixture containing the components other than the component (B) (which may be hereinafter abbreviated as a “polyol mixture”), and then mixing the polyol mixture with the polyisocyanate component (B).

Examples of the method for preparing the polyol mixture that is preferred from the standpoint of preventing the foaming agent (D) and the catalyst (E) from being in contact with each other include a method of blending the catalyst (E) with the polyol component (A), then blending the crosslinking agent (C) and the optional components, such as the foam stabilizer (F), therewith, and finally blending the foaming agent (D) therewith.

In the present invention, the polyol mixture preferably has a viscosity of 2,400 mPa·s or less at a liquid temperature of 25° C. This is because the efficiency in stirring of the polyurethane foaming liquid may be improved, thereby providing the desired polyurethane foam-molded article with sufficient and uniform foaming. In this point of view, the viscosity of the polyol mixture at a liquid temperature of 25° C. is preferably 1,800 mPa·s or less.

### Foam-Molding of Polyurethane Foam

The method of foam-molding the polyurethane foam employed may be a conventionally-known foam-molding method, in which the polyurethane foaming liquid is injected into a cavity formed in a mold, and foam-molded, and a timed pressure release (TPR) method is preferably employed in combination.

In the TPR in the present invention, the pressure in the mold is reduced to form interconnected air bubbles. More specifically, after the step of feeding the foaming liquid into the cavity formed in the mold and after 20 to 50 seconds passed from the gel time, a step of reducing the pressure in the mold by from 0.15 to 0.25 MPa may be performed.

The gel time referred herein means the time, at which after mixing a polyol and an isocyanate, the viscosity of the mixture is increased to provide a gel strength.

From the standpoint of preventing the components of the polyurethane foaming liquid from being separated, the polyurethane foaming liquid is prepared by mixing the components preferably immediately before injecting the polyurethane foaming liquid into the cavity of the mold. At this time, the liquid temperature of the foaming liquid is generally preferably from 10 to 50° C., more preferably from 20 to 40° C., and further preferably from 25 to 35° C. The order of mixing the components is not particularly limited, and from the standpoint of preventing an unnecessary increase in the viscosity of the polyurethane foaming liquid from occurring before preparing the same, at least the polyols as the component (A) and the isocyanate as the component (B) are preferably mixed finally with each other. Subsequently, immediately after preparing the foaming liquid, the foaming liquid is injected under the atmospheric pressure into the cavity of the mold, in which the cavity can be depressurized, and immediately after completing the injection, the depressurization is started. Thereafter, the foaming liquid is foamed and cured in the mold, and the product of the present invention is obtained by releasing it from the mold. The temperature of the mold is generally preferably from 40 to 80° C., more preferably from 50 to 70° C., and further preferably from 60 to 65° C.

### Properties of Polyurethane Foam

From the standpoint of preventing car sickness and improving the comfort to sit, the polyurethane foam of the present invention preferably has such properties as a stress relaxation of 11% or less, more preferably 10.5% or less, and most preferably less than 10%, which is generally said to be extremely good. From the standpoint of the durability, the hygrothermal compressive residual strain thereof is preferably 11% or less, more preferably 10.5% or less, and less than 10% is generally said to be extremely good.

The polyurethane foam of the present invention can suppress the shakiness, and the use thereof as a vehicle seat pad can suppress the inclination of the seat during turning a corner.

### Example

The present invention will be described in more detail with reference to examples below, but the present invention is not limited to the examples.

### Evaluation Methods

The urethane foams produced in Examples and Comparative Examples were evaluated by the following methods.

### (1) Overall Density

The overall density was an apparent density of the overall foam (unit: kg/m³) measured according to the method described in JIS K-6400. The weight (W) of the polyurethane foam molded into a rectangular parallelepipedal shape (350 mm×350 mm×70 mm in height) was measured, then the volume (V) of the rectangular parallelepiped was obtained from the length, the width and the height thereof, and the overall density (p) was calculated by the following expression.

ρ=(W/V)×10⁶
ρ: overall density (kg/m³)
W: mass of test piece (g)
V: volume of test piece (mm³)

In the examples, three types of specimens having overall densities of 62 kg/m³, 65 kg/m³ and 68 kg/m³ were measured for the following characteristic values.

### (2) 25% Hardness

The load (kgf) that was required for compressing a urethane foam by 25% under an environment of 23° C. and 50% RH by using an Instron type compression testing machine and was used as an index of the hardness.

### (3) Stress Relaxation (%)

The polyurethane foam was compressed by a distance equal to 75% of the initial thickness thereof at a velocity of 50 mm/min with a circular pressure plate having a diameter of 200 mm. Thereafter, the load was removed, and the polyurethane foam was allowed to stand for 1 minute. The polyurethane foam was again applied with a load at the same velocity, and at the time when the load reached 196 N (20 kgf), the pressure plate was stopped, and after allowing the urethane foam to stand for 5 minutes, the load was read out. The stress relaxation rate was calculated according to the following expression.

Stress relaxation rate (%)=100×(load when pressure plate was stopped (196 N)−load after allowing polyurethane foam to stand for 5 minutes)/load when pressure plate was stopped (196 N)

The smaller the value is, the more superior the polyurethane foam is in stress relaxation-reducing properties.

### (4) Hygrothermal Compressive Residual Strain (%)

The hygrothermal compressive permanent strain was measured by the measurement method for compressive residual strain described in JIS K-6400. In the measurement, a core portion of the molded polyurethane foam was cut into a dimension of 50×50×25 mm, and was used as a test piece. The test piece was compressed to a 50% thickness, held between parallel flat plates, and allowed to stand under a condition of 50° C. and 95% RH for 22 hours. Thereafter, the test piece was taken out, and after 30 minutes, was measured for the thickness of the test piece, which was compared to the thickness of the test piece before the test to measure the strain rate, and the strain rate was designated as the hygrothermal compressive residual strain, which was used as an index of the durability. The smaller the value is, the more superior the polyurethane foam is in durability.

### (5) Shakiness-Reducing Properties

The shakiness occurs in a frequency range around 1 Hz. Thus, the polyurethane foams obtained in the examples each were measured for the viscoelasticity (tanδ) at 1 Hz with a 100 Hz dynamic spring tester, produced by Saginomiya Seisakusho, Inc.

The larger the value is, the more superior the shakiness-reducing properties are.

### Examples 1 and 2 and Comparative Examples 1 and 2

Foaming liquids each were prepared according to the composition formulations shown in Table 1. In the preparation, a polyol mixture containing the components other than the polyisocyanate component (B) was prepared, and then the polyisocyanate component (B) was blended therewith. The polyol composition was prepared by mixing the catalyst (E) with the polyol component (A), then blending the crosslinking agent (C) and the foam stabilizer (F) therewith, and finally mixing the foaming agent (D) (water) therewith. During the preparation, the temperature of the polyurethane foaming liquid was controlled to 30° C.

Subsequently, immediately after the preparation of the foaming liquid, the foaming liquid was injected under the atmospheric pressure into a cavity of a mold with a preset temperature of 60° C., in which the cavity can be depressurized, and immediately after completing the injection, the depressurization was started. Thereafter, foaming and curing were performed in the mold, and when 30 seconds passed from the gel time, the pressure in the mold was reduced by 0.2 MPa. Thereafter, a polyurethane foam for a seat pad was obtained by releasing it from the mold. The resulting polyurethane foam was evaluated by the above-described methods. The evaluation results are shown in Table 1.

TABLE 1

| | | | | Example | | | | | |
|---|---|---|---|---|---|---|---|---|---|
| | | | | 1-1 | 1-2 | 1-3 | 2-1 | 2-2 | 2-3 |
| Composition of | (A) | Polyether polyol (a-1)¹⁾ | | 45 | 45 | 45 | 45 | 45 | 45 |
| foaming liquid | | Polyether polyol (a-2)²⁾ | | 5 | 5 | 5 | 5 | 5 | 5 |
| (part by mass) | | Polymer polyol (a-3)³⁾ | | 47 | 47 | 47 | 45 | 45 | 45 |
| | (C) | Crosslinking agent (C)-1⁴⁾ | | 3 | 3 | 3 | 5 | 5 | 5 |
| | | Crosslinking agent (C′)-2⁵⁾ | | | | | | | |
| | | Crosslinking agent (C′)-3⁶⁾ | | | | | | | |
| | (E) | Catalyst⁷⁾ | | 0.3 | 0.3 | 0.3 | 0.3 | 0.3 | 0.3 |
| | (F) | Silicone foam stabilizer⁸⁾ | | 0.7 | 0.7 | 0.7 | 0.7 | 0.7 | 0.7 |
| | (D) | Water | | 2.4 | 2.4 | 2.4 | 2.4 | 2.4 | 2.4 |
| | Total (excluding (B)) | | | 103.4 | 103.4 | 103.4 | 103.4 | 103.4 | 103.4 |
| | (B) | Polyisocyanate⁹⁾ | TDI/MDI | 80/20 | 80/20 | 80/20 | 80/20 | 80/20 | 80/20 |
| | | | (mass ratio) | | | | | | |
| Characteristic | Overall density (kg/m³) | | | 62 | 65 | 68 | 62 | 65 | 68 |
| values of | 25% Hardness | | | 21.4 | 24.3 | 26.1 | 22.4 | 25.3 | 28.1 |
| polyurethane foam | Stress relaxation (%) | | | 10.0 | 9.9 | 10.3 | 10.1 | 10.3 | 9.8 |
| | Hygrothermal compressive | | | 10.3 | 9.7 | 10.5 | 10.0 | 9.5 | 9.7 |
| | residual strain (%) | | | | | | | | |
| | 1 Hz Viscoelasticity (tanδ) | | | 0.213 | 0.215 | 0.214 | 0.215 | 0.219 | 0.216 |
| | | | | Comparative Example | | | | | |
| | | | | 1-1 | 1-2 | 1-3 | 2-1 | 2-2 | 2-3 |
| Composition of | (A) | Polyether polyol (a-1)¹⁾ | | 45 | 45 | 40 | 45 | 45 | 40 |
| foaming liquid | | Polyether polyol (a-2)²⁾ | | 5 | 5 | 10 | 5 | 5 | 5 |
| (part by mass) | | Polymer polyol (a-3)³⁾ | | 47 | 47 | 47 | 47 | 47 | 47 |
| | (C) | Crosslinking agent (C)-1⁴⁾ | | | | | | | |
| | | Crosslinking agent (C′)-2⁵⁾ | | 3 | 3 | 3 | | | |
| | | Crosslinking agent (C′)-3⁶⁾ | | | | | 3 | 3 | 3 |
| | (E) | Catalyst⁷⁾ | | 0.3 | 0.3 | 0.3 | 0.3 | 0.3 | 0.3 |
| | (F) | Silicone foam stabilizer⁸⁾ | | 0.7 | 0.7 | 0.7 | 0.7 | 0.7 | 0.7 |
| | (D) | Water | | 2.4 | 2.4 | 2.4 | 2.4 | 2.4 | 2.4 |
| | Total (excluding (B)) | | | 103.4 | 103.4 | 103.4 | 103.4 | 103.4 | 98.4 |
| | (B) | Polyisocyanate⁹⁾ | TDI/MDI | 80/20 | 80/20 | 80/20 | 80/20 | 80/20 | 80/20 |
| | | | (mass ratio) | | | | | | |

| | | | | | | | |
|---|---|---|---|---|---|---|---|
| Characteristic | Overall density (kg/m³) | 62 | 65 | 68 | 62 | 65 | 68 |
| values of | 25% Hardness | 22.8 | 25.8 | 28.1 | 24.8 | 26.9 | 29.0 |
| polyurethane foam | Stress relaxation (%) | 11.3 | 11.6 | 11.4 | 12.0 | 11.9 | 11.7 |
| | Hygrothermal compressive | 11.6 | 11.5 | 11.8 | 11.9 | 12.1 | 12.3 |
| | residual strain (%) | | | | | | |
| | 1 Hz Viscoelasticity (tanδ) | 0.201 | 0.205 | 0.195 | 0.199 | 0.192 | 0.199 |

[Note]
¹⁾Polyether polyol (a-1): EO/PO molar ratio: 13/87, number average molecular weight: 7,500, number of functional groups: 3
²⁾Polyether polyol (a-2): PO 100% by mol, number average molecular weight: 700, number of functional groups: 3
³⁾Polymer polyol (a-3): EO/PO molar ratio: 15/85, number average molecular weight: 5,000, number of functional groups: 3
⁴⁾Crosslinking agent (C)-1: polyether polyol, EO 100% by mol, number average molecular weight: 600, number of functional groups: 3, molecular weight per one functional group: 200
⁵⁾Crosslinking agent (C′)-2 (for comparison): polyether polyol, EO 100% by mol, number average molecular weight: 400, number of functional groups: 4, molecular weight per one functional group: 100
⁶⁾Crosslinking agent (C′)-3 (for comparison): polyether polyol, EO 100% by mol, number average molecular weight: 200, number of functional groups: 3, molecular weight per one functional group: 67
⁷⁾Catalyst: triethylenediamine and (2-dimethylaminoethyl)ether (produced by Tosoh Corporation
⁸⁾Silicone foam stabilizer: “SZ1325”, a trade name, produced by Dow Corning Toray Co., Ltd.
⁹⁾Polyisocyanate: TDI and MDI were mixed to make a TDI/MDI (mass ratio) of 80/20 and an NCO groups/active hydrogen groups in the foaming liquid (molar ratio) of from 95/15 to 100/0. (TDI: “Cosmonate (a registered trademark) T-80”, produced by Mitsui Chemicals, Inc., MDI: “MR-200HR”, produced by Nippon Polyurethane Industry Co., Ltd.)

It is understood from Table 1 that the polyurethane foam for a seat pad of the present invention is improved in the stress relaxation-reducing properties while maintaining the shakiness-reducing properties to higher levels. The hygrothermal compressive permanent strain is also improved, and thus the durability is more superior to the ordinary ones.

Comparative Examples 1 and 2, in which only a crosslinking agent outside the present invention is used, are inferior in the stress relaxation-reducing properties and the durability.

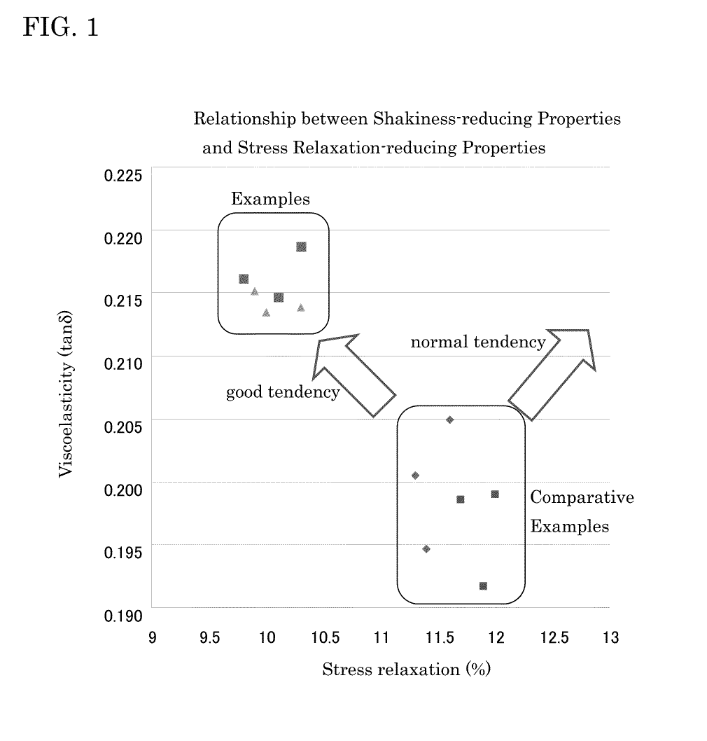

FIG. 1 is a graph showing the relationship between the stress relaxation (%) and the 1 Hz viscoelasticity (tanδ), which shows the relationship between the stress relaxation-reducing properties and the shakiness-reducing properties. In the graph, while it is a normal tendency that the plots are shifted to upper right, the plots of the polyurethane foams for a seat pad of the present invention are shifted to upper left, from which it is understood that good capability is obtained.

### INDUSTRIAL APPLICABILITY

The polyurethane foam of the present invention can achieve higher levels of shakiness-reducing properties and stress relaxation-reducing properties, and is also excellent in durability, and thus the polyurethane foam is suitable for a seat pad. In particular, the seat pad does not shake during turning a corner, and can suppress inclination of the human body when a centrifugal acceleration is applied to the human body during turning a corner, and therefore, the polyurethane foam of the present invention is also suitable as a seat pad for vehicles.

1. A polyurethane foam for a seat pad formed by foam-molding a foaming liquid containing (A) a polyol component, (B) a polyisocyanate component, and (C) a crosslinking agent, wherein:
the polyol component (A) comprises (a-1) a polyether polyol that is a block copolymer that is obtained through ring opening polymerization of ethylene oxide and propylene oxide, has a molar ratio of a repeating unit derived from ethylene oxide to a repeating unit derived from propylene oxide of from 5/95 to 25/75, and has a number average molecular weight of from 6,000 to 8,000, in a ratio of from 30 to 55% by mass in the polyol component (A) and (a-2) a polyether polyol that is obtained through ring opening polymerization of propylene oxide only, or ethylene oxide and propylene oxide, has a molar ratio of a repeating unit derived from ethylene oxide to a repeating unit derived from propylene oxide of from 0/100 to 20/80, and has a number average molecular weight of from 600 to 2,000, in a ratio of from 2 to 20% by mass in the polyol component (A); and
the crosslinking agent (C) comprises a polyether polyol that is obtained through ring opening polymerization of ethylene oxide only, and has a number average molecular weight of from 500 to 1,500.

2. The polyurethane foam for a seat pad according to claim 1, wherein an amount of the crosslinking agent (C) contained is from 0.5 to 10% by mass based on the total amount of the polyol component (A) and the crosslinking agent (C).

3. The polyurethane foam for a seat pad according to claim 1, wherein the polyol component (A) further comprises (a-3) a polymer polyol that is obtained through graft copolymerization of an acrylonitrile-styrene copolymer to a polyether polyol which is obtained through ring opening polymerization of ethylene oxide and propylene oxide, has a molar ratio of a repeating unit derived from ethylene oxide to a repeating unit derived from propylene oxide of from 5/95 to 25/75 and has a number average molecular weight of from 3,000 to 7,000, in a ratio of from 40 to 60% by mass in the polyol component (A).

4. A seat pad comprising the polyurethane foam according to claim 1.
